(19) United States
(12) Patent Application Publication
(10) Pub. No.: US 2021/0217108 A1
(43) Pub. Date: Jul. 15, 2021

(54) Systems and Methods for Validation of Online Content

(71) Applicant: The Ab Lab Company, Sherman Oaks, CA (US)

(72) Inventor: Linda Pfeffer, Sherman Oaks, CA (US)

(21) Appl. No.: 17/138,622

(22) Filed: Dec. 30, 2020

Related U.S. Application Data
(60) Provisional application No. 62/960,599, filed on Jan. 13, 2020.

(51) Int. Cl. G06Q 50/00; G06Q 30/02; G06F 16/9535; H04L 12/58

(52) U.S. Cl. CPC G06Q 50/01; H04L 51/32; G06F 16/9535; G06Q 30/02

(57) ABSTRACT

A system for the validation of online content. The system includes a website that displays one or more user veracity scores of a commenting user. Each user veracity score is associated with one or more comment posts of the user displayed in connection with one or more media content posts displayed on the website. The system also includes a website management module that determines the user veracity score based on one or more review scores associated with each of the comment posts. Each review score is provided by a respective one or more reviewing users.

### CROSS REFERENCE TO RELATED APPLICATIONS

This application claims the benefit of U.S. Provisional Application No. 62/960,599, entitled Systems and Methods for Validation of Online Content, filed on Jan. 13, 2020, which is hereby incorporated by reference in its entirety.

### FIELD OF THE INVENTION

The present invention relates to systems and methods for the validation of online content.

### BACKGROUND OF THE INVENTION

In general, website hosted content, particularly media content, may be subject to validation by other users of the hosting website. This typically occurs via such other users providing a virtual “like” or “dislike” with respect to the hosted content. These virtual “likes” and “dislikes” can impact the prominence of the content as it is provided via the hosted website. Accordingly, content that has accrued many “likes” will be more prominently provided than content that has accrued less “likes” (or more “dislikes”).

This leads to a problem, particularly when the hosted content is informational content, in that the users who provide the “likes” and “dislikes” may not be qualified to give an opinion on the content. Consequently, hosted content that may be false or misleading is potentially more prominently provided via the website than content that is true and accurate. This problem is further compounded by the general lack of accountability on websites for posting false or misleading media content and/or comments.

It is an object of the disclosure to provide systems and methods for the validation of online content, which address at least these shortcomings. Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples. The disclosure is written for those skilled in the art. Although the disclosure use terminology and acronyms that may not be familiar to the layperson, those skilled in the art will be familiar with the terminology and acronyms used herein.

### BRIEF DESCRIPTION OF THE DRAWINGS

The features, objects, and advantages of the present invention will become more apparent from the detailed description, set forth below, when taken in conjunction with the drawings, in which like reference characters identify correspondingly throughout and wherein:

FIG. 1 is a schematic view of an exemplary system according to at least one aspect of the invention;

FIG. 2 is a schematic view of an exemplary system architecture according to at least one aspect of the invention; and

FIG. 3 is an exemplary method according to at least one aspect of the invention.

FIG. 4 is a schematic view of exemplary profiles in accordance with at least one aspect of the invention.

### DETAILED DESCRIPTION OF THE DRAWINGS

The above described drawing figures illustrate aspects of the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one embodiment of the invention with the understanding that the present disclosure is to be considered as an exemplification of the principles of the present invention, and is not intended to limit the broad aspects of the present invention to any embodiment illustrated. It will therefore be understood that what is illustrated is set forth for the purposes of example, and should not be taken as a limitation on the scope of the present invention.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment.

Furthermore, the particular features, structures, or characteristics may be combined in any suitable manner on one or more embodiments without limitation. The term “or” as used herein is to be interpreted as inclusive or meaning any one or any combination.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, for brevity sake well-known methods, procedures, components, and circuits have not been described in detail.

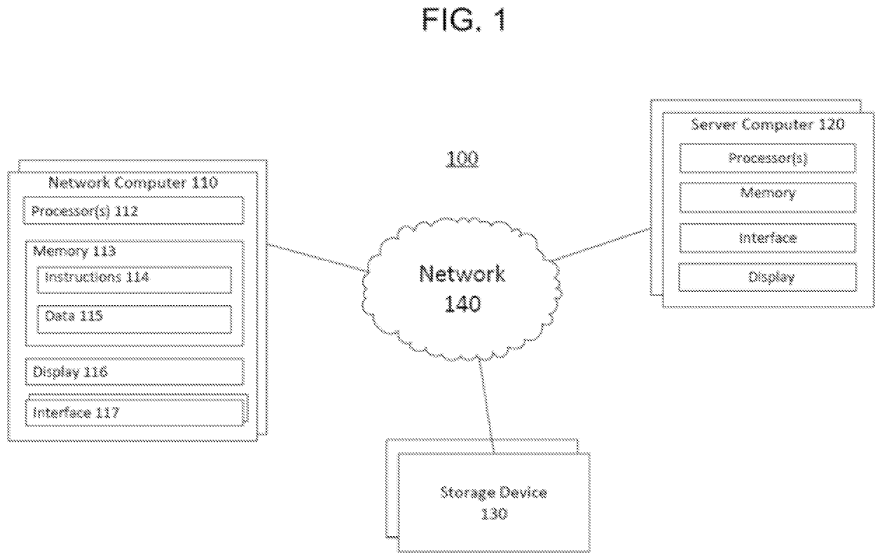

FIG. 1 illustrates an example system 100 in accordance with one or more aspects of the disclosure. In general, the system provides for the validation of online content, particularly media content.

System 100 may include a plurality of computers and/or computing devices, such as, network computer(s) 110, server computer(s) 120, and storage device(s) 130. By way of example only, network computer(s) 110 is/are connected to network 140 and may include different types of components associated with a computer, such as one or more processors 112, memory 113, instructions 114, data 115, display 116, and an interface 117. Server computer(s) 120 may include back-end server computers hosting an online platform (i.e., website) for posting, viewing and commenting on online content, particularly media content, as well as for reviewing comments to posted content.

The network computer(s) 110 include system and/or user computing devices, and may be mobile (e.g., laptop computer, tablet computer, smartphone, PDA, wearable, etc.) or stationary (e.g., desktop computer, etc.). In some aspects, the network computer(s) 110 include user devices configured to communicate information with the other computer devices on network 140.

The processor 112 of network computer 110 may instruct the components thereof to perform various tasks based on the processing of information and/or data that may have been previously stored or have been received, such as instructions 114 and/or data 115 stored in memory 113. The processor 112 may be a standard processor, such as a central processing unit (CPU), or may be a dedicated processor, such as an application-specific integrated circuit (ASIC) or a field programmable gate array (FPGA).

Memory 113 stores at least instructions 114 and/or data 115 that can be accessed by processor 112. For example, memory 113 may be hardware capable of storing information accessible by the processor, such as a ROM, RAM, hard-drive, CD-ROM, DVD, write-capable, read-only, etc. The set of instructions may be included in software that can be implemented on the network computer 110 and should be noted that the terms “instructions,” “steps,” “algorithm,” and “programs” may be used interchangeably. Data 115 can be retrieved, manipulated or stored by the processor 112 in accordance with the set of instructions 114 or other sets of executable instructions. The data 115 may be stored as a collection of data.

Accordingly, the network computer(s) 110 may include one or more software applications, stored in the memory 113, which software applications, when executed by the processor 110 configures the network computer(s) to function as described herein. In particular, the network computer(s) 110 may be configured to access the online platform hosted by the server computer(s) 120, and to send and/or receive data to and from the server computer(s) 120. The software may further configure the network computer(s) 110 to allow the user to post content to the website, view posted content, comment on posted content, and review comments via online platform.

The display 116 may be any type of device capable of communicating data to users, such as a liquid-crystal display (“LCD”) screen, a plasma screen, etc. Interface 117 allow users to communicate with the network computer 110 and may be a physical device (e.g., a port, a keyboard, a mouse, a touch-sensitive screen, microphone, camera, a universal serial bus (USB), CD/DVD drive, zip drive, card reader, etc.) and/or may be virtual (e.g., a graphical user interface “GUI,” etc.).

Server computer(s) 120 may also include one or more processors, memory, interface, and/or display and may be configured to communicate with other computer devices on network 140. The server computer(s) 120 may be rack mounted on a network equipment rack and/or located, for instance, in a data center. In one example, the server computer(s) 120 may use the network 140 to serve the requests of programs executed on network computer 110 and/or storage device 130.

The storage device 130 may be configured to store large quantities of data and/or information. For example, the storage device 130 may be a collection of storage components, or a mixed collection of storage components, such as ROM, RAM, hard-drives, solid-state drives, removable drives, network storage, virtual memory, cache, registers, etc. The storage device 130 may also be configured so that the network computer 110 and/or server computer 120 may access it via the network 140.

The network 140 may be any type of network, wired or wireless, configured to facilitate the communication and transmission of data, instructions, etc. from one component to another component of the network. For example, the network 140 may be a local area network (LAN) (e.g., Ethernet or other IEEE 802.03 LAN technologies), Wi-Fi (e.g., IEEE 802.11 standards, wide area network (WAN), virtual private network (VPN), global area network (GAN)), any combination thereof, or any other type of network.

It is to be understood that the network configuration illustrated in FIG. 1 serves only as an example and is thus not limited thereto. System 100, for instance, may include numerous other components connected to network 140, include more than one of each network component (as shown by the cascaded blocks), and network 140 may be connected to other networks.

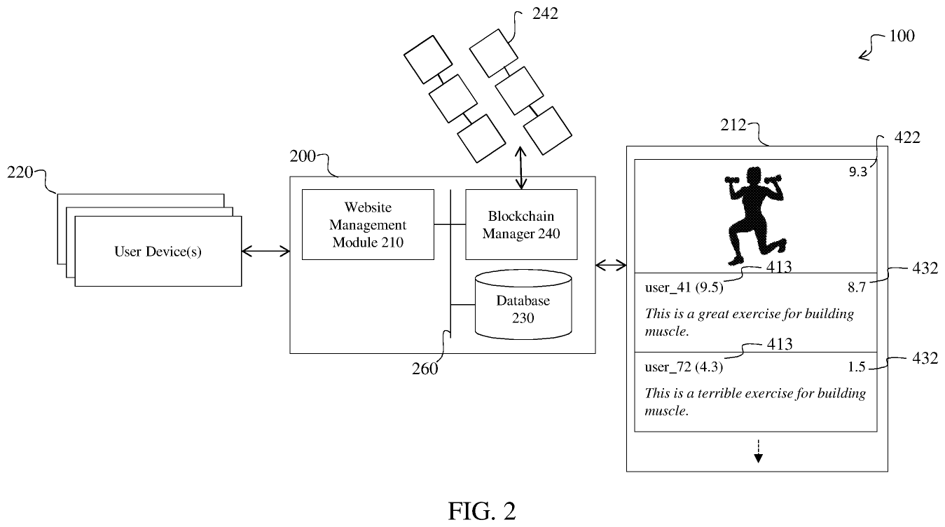

FIG. 2 illustrates an exemplary system architecture 200 in accordance with at least one embodiment. The system architecture includes a website management module 210, a blockchain manager 240 and a database 230, each communicatively coupled via an internal network 260 (e.g., data bus).

The website management module 210 is generally configured to host, manage and maintain a media content hosting website 250, and is communicatively coupled via the network 140 to one or more user devices 220, via which users interact with the website to post media content on the website, post comments with respect to the posted media content, and to review posted comments, such that a crowd sourced verification of one or more of posted media and comments is accomplished.

In general, the users may have one or more permissions or authorizations with respect to posting, commenting and/or reviewing. As such, some users may be authorized to post media, whereas others are authorized to comment on the media, and others are authorized to review comments. These authorizations may overlap for various users, and may be based on user credentials and such.

The comments to posted media content may therefore have comment veracity scores that are based on well-credentialed users providing reviews of the comments for accuracy. The users who posted such reviewed comments may also therefore have user veracity scores associated with them, which are based on the comment veracity scores of their associated comments. For example, a user whose comments are consistently reviewed to have lower comment veracity scores may have a lower user veracity score than another user whose comments are consistently reviewed to have higher comment veracity scores. The user veracity scores and comment veracity scores may be displayed with the posted comment. As user permissions overlap, the reviewing of comments by other commenting users trends towards a wisdom of the credentialed crowd check on untrustworthy comments.

The website management module may be configured to receive media content 252 from one or more user devices for posting on the website, in accordance with a user profile 410. Each user profile may correspond to a user identification 411 associated with that user profile. The received media content may be assigned a content identification 421 associated with the received media content. The received media content may be stored in the database in association with the content identification. The website management module may be configured to post and otherwise manage the received media content on the website.

The website management module may be configured to receive comments from one or more user devices, for posting on the website in connection with the posted media content. As used herein, the term “comment” and its derivatives include, for example, but not limited to: virtual likes, dislikes, thumbs-up, thumbs-down, ratings (e.g., scale ratings, star ratings, etc.) and text comments. Each comment may be stored in the database in association with a comment identification 431. The website management module may be configured to post and otherwise manage the received comments on the website.

The website management module may be configured to receive reviews from one or more user devices, in connection with posted comments. As used herein, the term “review” and its derivatives include, for example, but not limited to: virtual approval and disapproval of the comment, also includes ratings (e.g., scale ratings, star ratings, etc.). The website management module may be configured to receive reviews only from a subset of user profiles. For example, only user profiles of users authorized to provide reviews, may be received or otherwise accepted by the website management module. In some embodiments, the website management module may be configured to filter out or otherwise reject reviews received from unauthorized users. The website management module may be further configured to solicit reviews, in response to received comments, from authorized users. Each review may be stored in the database in association with a review identification 441. The website management module may be configured to post and otherwise manage the received reviews on the website.

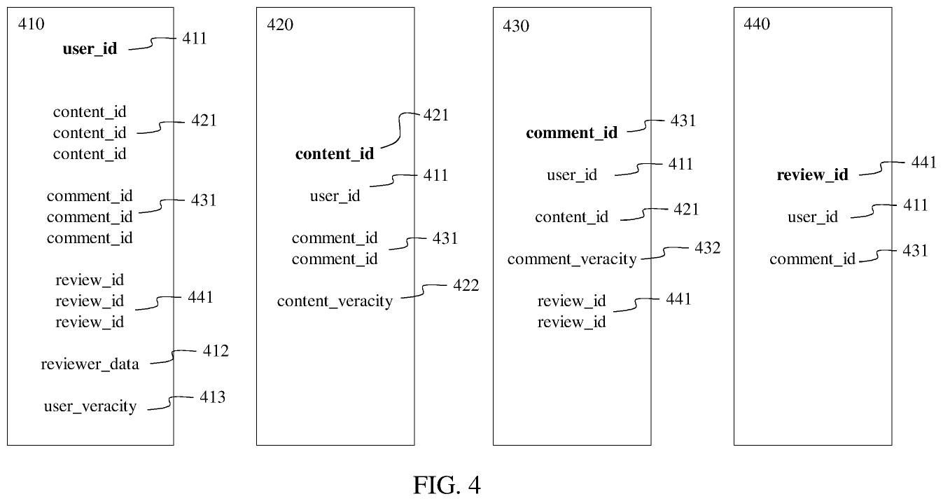

The website management module is operatively coupled to a database 230. The database may store user profiles for each of the users. An exemplary user profile is shown, for example, in FIG. 4. Where appropriate, each user profile may correlate the user identification with: each media content posted to the website by the user, via its respective content identification; each comment posted to the website by the user, via its respective comment identification; and each review tendered by the user, via its respective review identification.

Accordingly, one or more of the user profiles may include reviewer data 412 authorizing the user to review one or more media content and/or comments for veracity. For example, the reviewer data may comprise one or more data flags or other indicators identifying the user as authorized to review media content and/or comments in one or more fields (e.g., yoga, acupressure, nutrition, etc.) of the media content and/or comment. The reviewer data may be added, deleted and/or modified with respect to the user profile by a system administrator in accordance with system policies. For example, reviewer data authorizing the user to review media content and/or comments in one or more fields may be based on certifications or other credentials of the user in those fields. Such certifications may be uploaded to the user profile, via the user devices, and stored in the database for reference.

In some embodiments, at least one of the user profiles may include at least one user veracity score 413 that reflects the trustworthiness of the user with respect to associated posted media content, comments and/or reviews. The user veracity score may be a numerical or other indicator, e.g., a rating on a 10 point scale. In some embodiments, the user profile includes a single veracity score reflecting the overall trustworthiness of the user. However, it will be understood that the user profile may include a plurality of veracity scores, each indicating the trustworthiness of the user with respect to one or more fields (e.g., yoga, acupressure, nutrition, etc.).

The database may store the received media content in association with a media content profile 420 (e.g., a relational database table). An exemplary media content profile is shown, for example, in FIG. 4. The media content profile may include the content identification of the associated media content, as well as the user identification of the posting user. The media content profile may further include the comment identifications of any comments posted with respect to the media content. The media content profile may further include at least one content veracity score 422 that reflects the trustworthiness of the media content with respect to one or more fields (e.g., yoga, acupressure, nutrition, etc.) to which the content relates. Such fields may be indicated in the media content profile. As with the user veracity score, the content veracity score may be a numerical or other indicator, e.g., a rating on a 10 point scale.

The database may store the received comments in association with a respective comment profile 430 (e.g., a relational database table). An exemplary comment profile is shown, for example, in FIG. 4. The comment profile may include the comment identification of the associated comment, as well as the user identification of the posting user and the content identification of the media content to which the comment relates. The comment profile may further include at least one comment veracity score 432 that reflects the trustworthiness of the comment with respect to the media content. As with the other veracity scores, the comment veracity score may be a numerical or other indicator, e.g., a rating on a 10 point scale. The comment profile may further include the review identifications of any reviews associated with the comment.

The database may also store the received reviews in association with a respective review profile 440 (e.g., a relational database table). An exemplary review profile is shown, for example, in FIG. 4. The review profile may include the review identification of the associated review, as well as the user identification of the reviewing user and the comment identification of the comment to which the review relates.

Turning now to FIG. 2, in operation, one or more of the user veracity scores may be based on the comment veracity scores of one or more comments posted by the user. The user veracity scores may be determined, in at least one embodiment, via an aggregation of the relevant comment veracity scores. In some embodiments, a weighted average may be used to determine the user veracity scores. The weight afforded to each comment may be determined based on the number of reviews associated with the respective comment and/or the user veracity scores of the reviewing users.

In at least one embodiment, the user veracity score may be determined such that users whose comments are generally associated with lower comment veracity scores generally have lower user veracity scores. Preferably, the user veracity scores of respective fields (e.g., yoga, nutrition, etc.) are determined based solely on those comments associated with the same fields. In this way, the user veracity scores of a user may reflect that user's trustworthiness in respective fields.

The comment veracity scores may in turn be based on one or more reviews of the comments posted by the user—such reviews being by the reviewing user. The reviewing user is preferably highly credentialed or otherwise authorized to review other users' comments for veracity—particularly in the field of the comment. The comment veracity score may be determined, in at least one embodiment, via an aggregation of the reviews associated with the comment. In some embodiments, a weighted average may be used to determine the comment veracity scores. The weight afforded to each review may be determined based on the user veracity scores of the reviewing users. Accordingly, the reviewing users act to verify the comments of the commenting users.

It will be understood, however, that user groups may overlap. As such, reviewing users may also be commenting users, and vice versa. As such, comment veracity scores and user veracity scores are subject to a crowd source check on veracity—with the caveat that the reviewing permissions may be restricted to highly credentialed users so as to weight the veracity check towards the wisdom of the highly credentialed crowd.

In at least one embodiment, the content veracity score may be determined in similar manner, but based on the aggregation of comments (or portions thereof) which rate the content. In some embodiments, a weighted average may be used to determine the content veracity scores. The weight afforded to each comment may be determined based on the user veracity scores of the commenting users. The content veracity score may be additionally or alternatively based on the user veracity score of the posting user. Moreover, the user veracity score may also be based on the comments associated with the user posted content.

The website management module is further operatively coupled to a block chain manager 240, which is configured to generate and manage one or more block chains 242, in accordance with known block chain methodologies. Accordingly, the website management module may provide information and instructions to the block chain manager for executing one or more functions described herein. It will be understood that one or more blockchain or distributed ledger methodologies may be used to by the block chain manager to generate and manage the one or more block chains, such that the system is blockchain methodology agnostic.

The block chain manager may generate and manage a comment block chain. The comment block chain may include comment blocks, each comment block corresponding to a comment received for an item of media content posted on the website. Each comment block may include information regarding the comment, such that the comment block chain is a record of one or more comments received for the item of media content. Each comment block may, for example, include some or all of the information discussed herein with respect to the comment profile. As such, the comment block chain may duplicate or replace the comment profile in at least some respects. Each comment block may also include its own comment block hash value and the comment block hash value of the previous block in the comment block chain. It will be understood that, while reference is made to the comment blockchain, the principles described are equally applicable to comment blocks on a common blockchain of which comment blocks and review blocks are a part.

The block chain manager may generate and manage a review block chain. The review block chain may include review blocks, each review block corresponding to a received review for the comment to the posted media content. Each review block may include information regarding the review, such that the review block chain is a record of one or more received reviews for the associated comment. Each review block may, for example, include some or all of the information discussed herein with respect to the review profile. As such, the review block chain may duplicate or replace the review profile in at least some respects. Each review block also includes its own review block hash value and the review block hash value of the previous block in the review block chain. In some embodiments, the user identification can be omitted. It will be understood that, while reference is made to the review blockchain, the principles described are equally applicable to comment blocks on the common blockchain

The website management module may be configured to retrieve and analyze information stored on any of the block chains. In particular, the website management module may be configured generate one or more metrics based on one or more comments, commenting user credentials, reviews, and/or reviewing user credentials.

The website management module, in association with at least the database, may maintain the one or more user veracity scores for each user profile. The user veracity scores may be determined based on uploaded certifications and/or credentials of the user. For example, additional certifications and positive reviews of comments posted by the user may each positively impact the user veracity score of the user, and vice versa. The user veracity score may also be based on the comment veracity scores of one or more comments posted by the user and/or based on the content veracity scores of one or more content posted by the user. For example, other highly credible users commenting favorably on media content posted by the user may positively impact the user veracity score of the user, and vice versa. The user veracity score of the user may also be based on reviews provided by the user. For example, reviews that are contrary to an overwhelming consensus of other reviewing users with high user veracity scores may negatively impact the user veracity score of the user, and vice versa.

The website management module may be further configured to manage the website in response to the information stored on the block chains and/or the database. The website management module may be configured to make the credentials of commenting and/or reviewing users available to viewers of the media content and/or the associated comments. For example, overlays to individual comments on a cooking recipe video can be provided, by which a user can view the credentials of the commenting user and/or the credentialed reviews of that comment.

The website management module may be configured to make one or more metrics available to viewers of the media content and/or the comments. For example, overlays to a sporting technique instructional video can be provided, by which a user can see what percentage of users with what qualifications agree or disagree with the video.

The website management module may be configured to manage the prominence of the media content and/or associated comments based on the comments, the credentials of the commenting users, the reviews, the credentials of the reviewing users, and/or the metrics thereof. For example, a video advertising a nutritional supplement may be removed or otherwise taken down from the website, where the analysis of the comments, commenting users, reviews and/or reviewing users indicates that the advertised benefits of the supplement are unsupported.

The website management module may be configured to provide one or more overlays to the media content posted on the website. The overlays may be based on the comments, commenting users, reviews and/or reviewing users. For example, an overlay of an exercise video may indicate a correction to the technique being shown on the video. That correction may be generated based on an analysis of comments to the video, which may be verified by the reviews of the comments by certified users.

In at least one embodiment, as shown in FIG. 2, for example, the website may display comments of various users in connection with respective user veracity scores and/or comment veracity scores. The website may additionally or alternatively display the respective content veracity score of the uploaded content.

Accordingly, by operation of the principles discussed herein, the veracity of the media content may be substantively ensured via the vetting of the comments thereto in a manner that provides accountability to the vetting and commenting users.

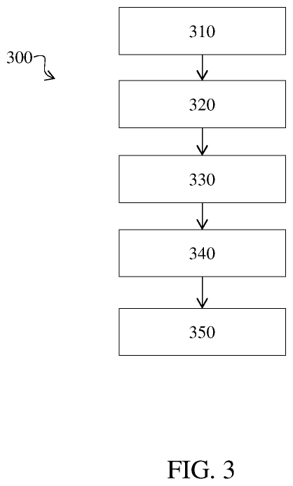

FIG. 3 illustrates an exemplary method 300 in accordance with at least one embodiment.

In step 310, media content is posted to the website. The media content may be any media content, including but not limited to: audio, visual, audio-visual, textual, haptic and other types of media content. The website is preferably configured to allow for posting, viewing and commenting on online content, particularly media content, as well as for permitting users to review comments to posted content.

In step 320, a user submits a comment to an item of media content posted on the website, and the comment is posted to the website to be displayed in connection with the item of media content.

In step 330, a new comment block for the comment block chain is generated and added to the comment block chain. Where the comment is an originating comment, the comment block originates the comment block chain. The comment block includes information regarding the comment, such that the comment block chain is a record of one or more comments received for the item of media content. The comment block includes, for example: the comment, the user identification of the user device sending the comment, and the content identification of the media content to which the comment is directed. Thus, the comment block chain provides an immutable record of the comments to the posted content.

In step 340, a review of the comment is received and a review block is generated and added to the review block chain. Where the review is an originating review, the review block originates the review block chain. The review block may include information regarding the review, such that the review block chain is a record of one or more received reviews for the comment. The review block includes, for example: the review, the user identification of the user device sending the review, and the comment block hash value of the comment to which the review pertains. Thus, the review block chain provides an immutable record of the reviews of a comment.

In step 350, the posted comment and/or media content is managed based on the comment block chain and the review block chain. For example, the analytics, or derivatives thereof, may be posted in connection with the posted content, the posted comment and/or the user profile of the commenting user.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements. In particular, for example, the functionalities of two or more various block chains discussed herein may be combined into a single block chain, or vice versa.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

1. A system for the validation of online content, comprising:
a website configured to display one or more user veracity scores of a commenting user, wherein each user veracity score is associated with one or more comment posts of the user displayed in connection with one or more media content posts displayed on the website; and
a website management module configured to determine the user veracity score based on one or more review scores associated with each of the comment posts, each review score provided by a respective one or more reviewing users.

2. The system of claim 1,
wherein the website is further configured to display one or more comment veracity scores respectively in connection with the one or comment posts, and
wherein the website management module is further configured to determine the one or more comment veracity scores based on the one or more review scores associated with the respective comment post.

3. The system of claim 2, wherein the user veracity scores are determined via aggregating comment veracity scores of the one or more comment posts associated with the commenting user.

4. The system of claim 3, wherein the aggregation of comment veracity scores is a weighted aggregation according to the user veracity scores of the respective reviewing users.

5. The system of claim 1,
wherein the website is further configured to display a content veracity score in association with each of the one or more media content posts, and
wherein the website management module is further configured to determine the content veracity score based on at least one of: the user veracity score, and the one or more comment veracity scores.

6. The system of claim 1, further comprising:
one or more user profiles, each user profile associated with a respective user, each user profile including:
one or more discipline categories, each discipline category associated with at least one of the one or more media content posts; and
the one or more user veracity scores of the respective user, each user veracity score corresponding to a respective discipline category.

7. The system of claim 6, wherein the user veracity scores are determined via aggregating comment veracity scores of the one or more comment posts associated with the commenting user for respective discipline categories.

8. The system of claim 7, wherein the aggregation of comment veracity scores is a weighted aggregation according to the user veracity scores of the respective reviewing users.

9. The system of claim 1, further comprising:
one or more user profiles, each user profile associated with a respective user and authorizing the respective user for at least one of: content viewing, content posting, commenting, and reviewing.

10. The system of claim 1, further comprising:
a blockchain manager configured to manage a blockchain to record the comment posts and review scores.
